(19) United States
(12) Patent Application Publication
(10) Pub. No.: US 2024/0328262 A1
(43) Pub. Date: Oct. 3, 2024

(54) BINDERLESS OR CATALYST-FREE REVOLVING PDC CUTTER

(71) Applicant: SAUDI ARABIAN OIL COMPANY, Dhahran (SA)

(72) Inventors: Guodong Zhan, Dhahran (SA); Msalli A. Otaibi, Dhahran (SA); Fawaz M. Albahesh, Dammam (SA)

(73) Assignee: SAUDI ARABIAN OIL COMPANY, Dhahran (SA)

(21) Appl. No.: 18/194,186

(22) Filed: Mar. 31, 2023

(51) Int. Cl. E21B 10/52; B23B 27/14; E21B 10/633

(52) U.S. Cl. CPC E21B 10/52; B23B 27/148; E21B 10/633; B23B 2226/315

(57) ABSTRACT

A cutting element has an upper body and a shaft extending from a lower side of the upper body. The upper body includes a cutting face opposite the lower side and bordered by a cutting edge, a side surface extending from the cutting edge, wherein an upper body diameter is measured between the side surface, and a catalyst-free polycrystalline diamond (CFPCD) portion forming the cutting face, the cutting edge, and at least a portion of the side surface. The CFPCD portion has a diamond matrix formed of a plurality of bonded together diamond grains, wherein diamond forms at least 99 percent by volume of the CFPCD portion, and wherein the CFPCD portion extends at least 1 mm from the cutting face. The shaft has a circumferential groove extending around its circumference and a shaft diameter less than the upper body diameter.

### BACKGROUND

Cutting elements fixed in drill bits and other downhole cutting tools are used to shear or crush downhole formations to drill into such formations, for example, to create wells. Depending on the formation and drilling application, cutting elements are typically made of metal, cermet, and/or diamond components.

Diamond is often provided as a polycrystalline diamond (PCD) layer to form cutting elements, sometimes referred to as polycrystalline diamond compact (PDC) cutters. For example, a typical PDC cutter includes a layer of PCD mounted to a substrate, which may be formed of cemented carbide or other cermet material. The PDC cutting element may then be mounted to a drill bit or other downhole cutting tool (e.g., a reamer), for example, by brazing the substrate of the cutting element into a pocket in the cutting tool. PCD layers are commonly mounted to substrates by forming the PCD layer on the substrate or attaching a preformed PCD layer to a substrate using high pressure high temperature (HPHT) sintering.

In conventional methods for forming PDC cutting elements, a binder or catalyst is used to form PCD and/or attach the PCD layer to the substrate. For example, in a typical process, diamond particles are positioned on a surface of a substrate in an assembly which is loaded in a HPHT press. The assembly may then be sintered under HPHT conditions in the presence of a catalyst material, e.g., a solvent catalyst material such as cobalt, nickel, or iron, that is used for facilitating the intergrowth of diamond particles. Catalyst material may be provided, for example, as a separate layer in the assembly, mixed with the diamond particles, or in the substrate. When catalyst material is provided from the substrate (e.g., in a cobalt-cemented tungsten carbide substrate), the catalyst may liquefy and sweep from the substrate into the interstitial regions between the diamond particles during sintering. The catalyst material is then used to cause the diamond particles to bond to one another (in diamond-to-diamond bonds) to form a matrix of bonded diamond grains defining the PCD material with interstitial regions between the bonded diamond grains being occupied by the catalyst material as a binder.

Because the presence of catalyst material in PCD can reduce the thermal stability of the PCD at elevated temperatures such as experienced during drilling operations, catalyst material around the cutting portions of PDC cutters is commonly removed by leaching processes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to revolving cutting elements having an upper body and a shaft extending from a lower side of the upper body. The upper body may include a cutting face opposite the lower side and bordered by a cutting edge, a side surface extending from the cutting edge, wherein an upper body diameter is measured between the side surface, and a catalyst-free polycrystalline diamond (CFPCD) portion forming the cutting face, the cutting edge, and at least a portion of the side surface. The CFPCD portion includes a diamond matrix formed of a plurality of bonded together diamond grains, wherein diamond forms at least 99 percent by volume of the CFPCD portion, and wherein the CFPCD portion may extend at least 1 mm from the cutting face. The shaft may have a circumferential groove extending around the circumference of the shaft a shaft diameter less than the upper body diameter.

In another aspect, embodiments disclosed herein relate to downhole tools having CFPCD revolving cutting elements mounted thereto. For example, a downhole tool may include a body having a central axis extending longitudinally therethrough, a blade extending outwardly from the body, a pocket formed in an outer surface of the blade, and a revolving cutting element rotatably mounted in the pocket. The revolving cutting element may have an upper body including a cutting face bordered by a cutting edge, a side surface extending from the cutting edge, wherein an upper body diameter is measured between the side surface, and a CFPCD portion forming the cutting face, the cutting edge, and at least a portion of the side surface. The revolving cutting element may also have a shaft extending from a lower side of the upper body opposite the cutting face, the shaft having a circumferential groove extending around its circumference and a shaft diameter less than the upper body diameter. A locking mechanism may be positioned between the pocket and the shaft, wherein the locking mechanism extends into the circumferential groove, to rotatably retain the revolving cutting element to the pocket.

In yet another aspect, embodiments disclosed herein relate to methods of forming a revolving cutting element that include forming a catalyst-free polycrystalline diamond (CFPCD) body by subjecting a volume of diamond powder to ultrahigh pressure and high temperature (UHPHT) sintering without the presence of a catalyst or binder material, where the UHPHT sintering includes an ultrahigh pressure ranging from 14 to 35 GPa and an ultrahigh temperature ranging from 1,730 to 2,730° C. The CFPCD body may form a cutting face, a cutting edge, and at least a portion of a side surface of the revolving cutting element. The revolving cutting element also includes a shaft having a circumferential groove extending around a circumference of the shaft. The revolving cutting element may be installed in a pocket formed in an outer surface of a cutting tool by inserting the shaft of the revolving cutting element into the pocket and providing a locking mechanism between the shaft and the pocket, wherein the locking mechanism extends into the circumferential groove of the shaft.

Other aspects and advantages will be apparent from the following description and the appended claims.

### BRIEF DESCRIPTION OF DRAWINGS

Wherever possible, like or identical reference numerals are used in the figures to identify common or the same elements. The figures are not necessarily to scale and certain features and certain views of the figures may be shown exaggerated in scale for purposes of clarification.

FIG. 1 shows a pressure-temperature diagram with pressure and temperature conditions used to form CFPCD according to embodiments of the present disclosure.

FIG. 2A shows a diagram of a conventionally formed PCD microstructure, and FIG. 2B shows a diagram of a microstructure of CFPCD according to embodiments of the present disclosure.

FIG. 3 shows a revolving cutter according to embodiments of the present disclosure and its assembly into a cutting tool.

FIGS. 4-7 show cross-sectional views of revolving cutters according to embodiments of the present disclosure.

FIGS. 8 and 9 show a perspective view and a top view, respectively, of a revolving cutter according to embodiments of the present disclosure.

FIG. 10 shows a perspective view of a revolving cutter according to embodiments of the present disclosure.

FIG. 11 shows a cross-sectional view of the revolving cutter in FIG. 10 taken at a longitudinal cross-section extending along the central longitudinal axis of the revolving cutter.

FIG. 12 shows a cross-sectional view of a revolving cutting element mounted to a cutting tool according to embodiments of the present disclosure.

FIG. 13 shows a cross-sectional view of a revolving cutting element mounted to a cutting tool according to embodiments of the present disclosure.

FIG. 14 shows a revolving cutting element according to embodiments of the present disclosure.

FIG. 15 is a cross-sectional view of the revolving cutting element shown in FIG. 14 mounted to a cutting tool according to embodiments of the present disclosure.

### DETAILED DESCRIPTION

Embodiments of the present disclosure are described below in detail with reference to the accompanying figures. In the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Embodiments of the present disclosure relate generally to revolving cutting elements formed with binderless or catalyst free polycrystalline diamond (CFPCD). As described herein, revolving cutting elements include cutters that, when mounted to a cutting tool, are rotatable about their central, longitudinal axis. CFPCD refers to a polycrystalline diamond (PCD) material that is formed using ultrahigh pressure and temperature (UHPHT) without a binder or catalyst material.

CFPCD may be formed by subjecting a volume of diamond powder to UHPHT conditions in the absence of a catalyst or binder material, where UHPHT conditions may include an ultrahigh pressure ranging from 10 to 35 GPa, and an ultrahigh temperature of 1,000° C. or more. For example, a UHPHT sintering process may include sintering under pressures of at least 14 GPa, at least 16 GPa, or at least 20 GPa and up to 25 GPa, up to 30 Gpa, or up to 35 GPa and under temperatures ranging from 1,730 to 2,730° C.

According to embodiments of the present disclosure, UHPHT sintering processes used to form CFPCD may include using a multi-anvil press to subject a volume of diamond powder to a schedule of increasing temperature and pressure. For example, the volume of diamond powder may be preheated, e.g., to a temperature ranging between 1,000-1,200° C., and pre-pressurized, e.g., to a pressure up to about 5 GPa. After pre-treating and while the volume of diamond powder is preheated, the pressure may then be increased over a period of time to an ultrahigh pressure, such as 14 GPa or more (e.g., 16 GPa). Then, while maintaining the ultrahigh pressure, the temperature may be increased from the preheated temperature to an increased, ultrahigh temperature, e.g., between greater than 1,200° C. and 2,000° C.

During the UHPHT sintering process, the volume of diamond powder may be held in a cavity in a multi-anvil cubic press capable of transferring ultrahigh pressures via multiple fitted-together anvils to the volume of diamond powder (e.g., through a pressure-transmitting medium in some embodiments). The cavity may have a shape that corresponds to the intended shape of the CFPCD body or that corresponds to a block form that may be subsequently cut to a selected shape. For example, when forming a CFPCD body or block form having a cylindrical shape, the cavity may have a corresponding cylindrical shape. In some embodiments, the cavity may be formed in a canister, where the volume of diamond powder is filled into the cavity of the canister, and the canister is centrally positioned between the anvils in the multi-anvil cubic press. In some embodiments, the volume of diamond powder may be pre-pressed into a pellet, e.g., having a relative density ranging from 70-80%, which may then be positioned in the cavity for UHPHT sintering. Additionally, in some embodiments, a foil or other electrically conductive material may be provided around the cavity walls which may act as a heater to heat the diamond powder when an electric current is applied.

In some embodiments, the volume of diamond powder may have an average grain size ranging between 0.5 micrometers (μm) and 50 μm, for example, between 8 μm and 20 μm. In some embodiments, the volume of diamond powder used to form CFPCD may be a high purity diamond composition, e.g., where at least 99 percent by volume is diamond. Further, the entire volume of diamond powder sintered under UHPHT conditions may have a high purity diamond composition, where the volume of diamond powder may have at least 99 percent by volume (e.g., at least 99.9%) diamond, excluding porosity, with no catalyst material or binder material mixed in the volume of diamond powder. In some embodiments, small amounts of other carbon forms such as amorphous diamond may be provided with the volume of diamond powder.

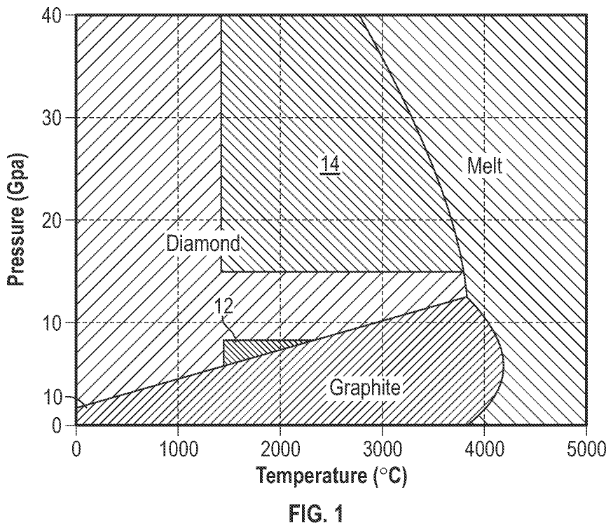

By using UHPHT to sinter a diamond body, the diamond grains may bond together in a polycrystalline diamond matrix without the use of a catalyst. As shown by the diamond-graphite phase diagram in FIG. 1, the stable form of crystalline carbon at pressures and temperatures above the diamond-graphite equilibrium line 10 is diamond. Higher pressures and/or higher temperatures (HPHT) generate higher energy to assist in converting diamond powder (or graphite powder) to bulk diamond in the kinetic formation of polycrystalline diamond in the HPHT condition. Conventionally, metal catalysts have been used to assist in diamond-to-diamond bonding to form PCD under relatively lower HPHT pressures and temperatures, e.g., at 5.5 GPa and 1,400° C., as shown by the traditional HPHT conditions 12 in FIG. 1. Diamond growth occurs at different temperatures and pressures in the presence of selected metal catalysts above the diamond-graphite equilibrium line 10. However, the energy generated by UHPHT conditions 14, as shown in FIG. 1, may be sufficient to form bulk polycrystalline diamond without metal catalyst, referred to as CFPCD.

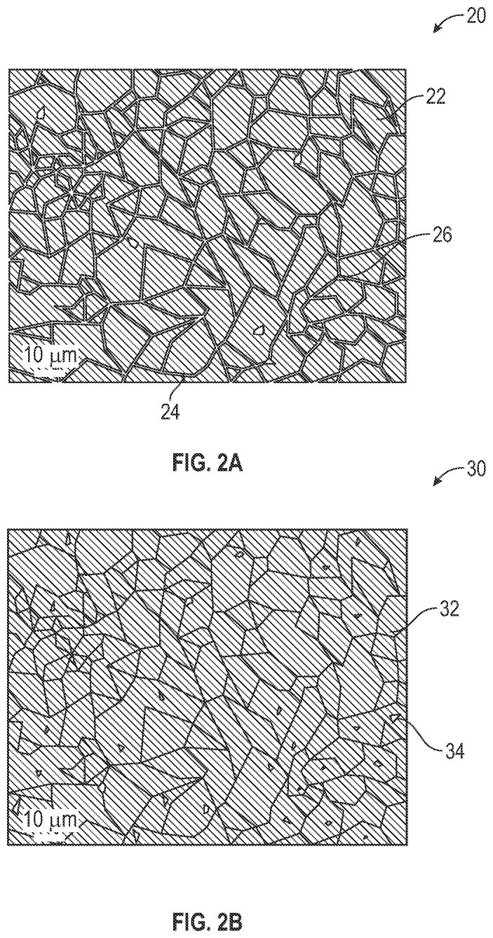

As such, CFPCD may have a different microstructure than that of PCD formed using a binder or catalyst material. For example, FIGS. 2A and 2B show a comparison between conventional PCD and CFPCD, where FIG. 2A shows an example of a conventionally formed PCD microstructure 20, and FIG. 2B shows an example of a CFPCD microstructure 30. The same starting diamond powder (having an average grain size of about 10 μm) was used to form both the PCD and CFPCD samples of FIGS. 2A and 2B.

As shown in FIG. 2A, the PCD microstructure 20 is formed of a diamond matrix of bonded together diamond grains 22 and an interstitial matrix of connected together interstitial regions 24 between the bonded together diamond grains 22. Interstitial regions that are not connected to other interstitial regions may be referred to as isolated interstitial regions. When forming conventional PCD using traditional HPHT conditions (e.g., 12 in FIG. 1), catalyst material may be present in the interstitial regions throughout the final PCD microstructure. While methods have been developed to leach catalyst material from conventional PCD structures, even using the most effective methods of leaching, residual amounts of catalyst material 26 may remain in isolated interstitial regions, as there is no connected interstitial region pathway for treatment of isolated interstitial regions. However, due to the ultra-high pressure used when forming CFPCD, the CFPCD microstructure 30 will have little to no porosity (e.g., less than 1% by volume). Further, because diamond grains 32 may be sintered together without the use of a binder or catalyst when forming CFPCD, whatever interstitial regions 34 are present in the CFPCD microstructure 30 would be void of any catalyst or binder material. For example, a CFPCD microstructure may be identified as having all or most of its interstitial regions free (0% by volume) of catalyst or binder material. Thus, according to embodiments of the present disclosure, CFPCD may have a composition where most or all of the material forming CFPCD is diamond, for example, 99.9-100% by volume diamond with any remainder non-diamond material being contaminants or residual impurities.

As used herein, catalyst or binder material may refer to material conventionally used to form conventional PCD. For example, common catalyst material used to form PCD includes metal solvent catalysts such as transitional metals in Group VIII of the Periodic table, e.g., cobalt, iron, nickel, or combinations thereof. Conventional PCD materials have also been formed using carbonate binders (e.g., alkaline earth metal carbonates), silicon containing materials, or other non-diamond materials.

According to embodiments of the present disclosure, CFPCD bodies may be formed into revolving cutting elements, where CFPCD may form the surfaces of the revolving cutting element designed to contact a working surface (e.g., an earthen formation), also referred to as the cutting portion of the cutting element. For example, a revolving cutting element according to embodiments of the present disclosure may include an upper body having a cutting face bordered by a cutting edge, a side surface extending from the cutting edge, and a CFPCD portion forming the cutting face, the cutting edge, and at least a portion of the side surface. The CFPCD portion may have a microstructure including a diamond matrix of a plurality of bonded together diamond grains, which may have less than 1 percent by volume porosity (formed by interstitial regions void of any catalyst or binder material).

Revolving cutting elements according to embodiments of the present disclosure may further include a shaft extending from a lower side of the upper body, opposite the cutting face. The shaft may have a shaft diameter less than the upper body diameter (as measured between opposite sides of the upper body side surface). The shaft may also include one or more circumferential grooves extending around the circumference of the shaft, which may be used to receive a locking mechanism to rotatably retain the revolving cutting element to a tool.

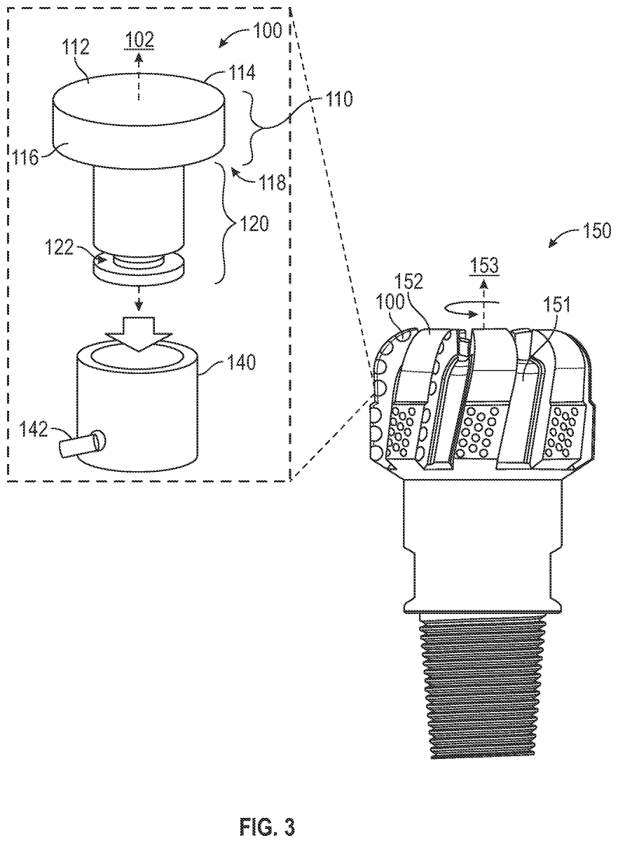

For example, FIG. 3 shows a revolving cutter 100 according to embodiments disclosed herein and its installation on a cutting tool 150 allowing the revolving cutter 100 to rotate about its central longitudinal axis 102 while being retained to the cutting tool 150. In the embodiment shown, the cutting tool 150 is a drill bit having a body 151, a central axis 153 extending longitudinally through the body 151, and at least one blade 152 extending outwardly from the body 151. At least one pocket (cavity) may be formed in an outer surface of each blade 152, where revolving cutters 100 according to embodiments of the present disclosure may be rotatably retained to one or more of the pockets. As shown, the pockets may be formed along a leading edge of a blade 152, where the leading edge of a blade refers to an edge formed on a side of the blade facing in the direction of the cutting tool's rotation about its central axis 153. In such configuration, as the cutting tool 150 is rotated about its central axis 153, the cutting elements mounted in the blade pockets may contact and drill through a working surface. Although a drill bit is shown as the cutting tool 150 in FIG. 3, revolving cutting elements according to embodiments of the present disclosure may be similarly mounted to pockets formed along cutting surfaces or edges of other types of cutting tools, such as reamers, other types of drill bits, or other types of downhole cutting tools.

According to embodiments of the present disclosure, a revolving cutter may be mounted to a cutting tool pocket using a sleeve. For example, as shown in FIG. 3, a shaft 120 portion of the revolving cutter 100 is inserted into a sleeve 140, where a locking mechanism 142 may extend from the sleeve 140 into a groove 122 in the shaft 120 to rotatably retain the cutting element 100 to the sleeve 140. In the embodiment shown, a locking mechanism 142 is a pin that is inserted through the sleeve 140 to extend into the groove 122. However, other locking mechanisms may be envisioned that extend from the sleeve into a revolving cutter groove to rotatably connect the revolving cutter to the sleeve. Further, the sleeve 140 is attached within a pocket formed along a blade 152 of the cutting tool 150, such that the revolving cutter 100 is rotatably retained to the cutting tool 150 via the sleeve 140 and locking mechanism 142. In some embodiments, discussed more below, a revolving cutter may be rotatably retained directly to a cutting tool without the use of a sleeve.

The revolving cutter 100 may be installed on the cutting tool 150 such that a cutting edge 114 of the revolving cutter 100 is exposed along a cutting surface of the cutting tool blade 152. In such manner, when the cutting tool 150 is in operation, e.g., drilling a working surface, the cutting edge 114 of the revolving cutter 100 may contact the working surface. Movement of the cutting tool 150 relative to the working surface may cause rotation of the revolving cutter 100 as it contacts the working surface. As shown in FIG. 3, the cutting edge 114 of the revolving cutter 100 is formed between a cutting face 112 and a side surface 116 of an upper body 110 portion of the revolving cutter 100. Particularly, the cutting edge 114 extends around and forms the perimeter of the cutting face 112, and the side surface 116 extends downwardly from the cutting edge 114 to define an upper body diameter. In some embodiments, the cutting edge 114 may be angled (e.g., with a bevel) or rounded. The shaft 120 extends from a lower side 118 of the upper body 110, opposite the cutting face 112. The upper body diameter is greater than the shaft diameter, which allows the shaft 120 of the revolving cutter 100 to be inserted into the sleeve 140 (or directly into a cutting tool pocket) to rotatably retain the cutter to the cutting tool 150 while the upper body 110 and cutting edge 114 remains at least partially exposed along a cutting surface of the cutting tool.

In the embodiment shown in FIG. 3, the revolving cutter 100 has a planar cutting face 112 and a continuously curved side surface 116 (e.g., having a constant radius of curvature around the entire side surface to define a circle cross-sectional shape). However, by using CFPCD to form the cutting portion of a revolving cutter, which has increased toughness, wear resistance, and hardness when compared with conventionally formed PCD, other upper body geometries may be utilized to form the cutting portion of a revolving cutter, including irregular geometries, geometries that are axi-symmetric about the central axis, and/or geometries that are axi-asymmetric about the central axis, as discussed more below.

Additionally, in the embodiment shown in FIG. 3, the shaft 120 includes a single circumferential groove 122 extending around the entire circumference of the shaft 120. In some embodiments, more than one circumferential groove may be formed at different axial positions along the shaft, where each circumferential groove extends around the entire circumference of the shaft.

According to embodiments of the present disclosure, a CFPCD body may form the entire cutting face, the entire cutting edge, and at least a portion of the side surface. For example, in some embodiments, a CFPCD body forming the entire cutting face, the entire cutting edge, and at least a portion of the side surface may extend at least 1 mm from the cutting face. In some embodiments, the entire upper body may be formed of CFPCD.

As discussed herein, CFPCD provides improved material characteristics when compared with conventional PCD, such as increased hardness, increased thermal stability, increased toughness, and increased impact resistance. Additionally, in contrast to conventional methods of forming PCD cutters, which require the use of a substrate, methods of forming CFPCD and resulting material properties of CFPCD allow an entire cutter to be formed of the CFPCD. Thus, in some embodiments, a CFPCD body may form the entire cutter, including the upper body and shaft.

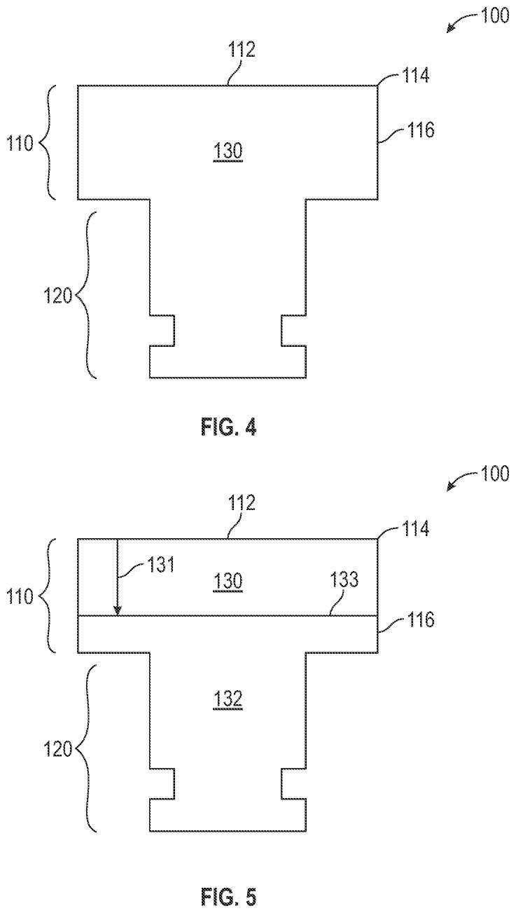

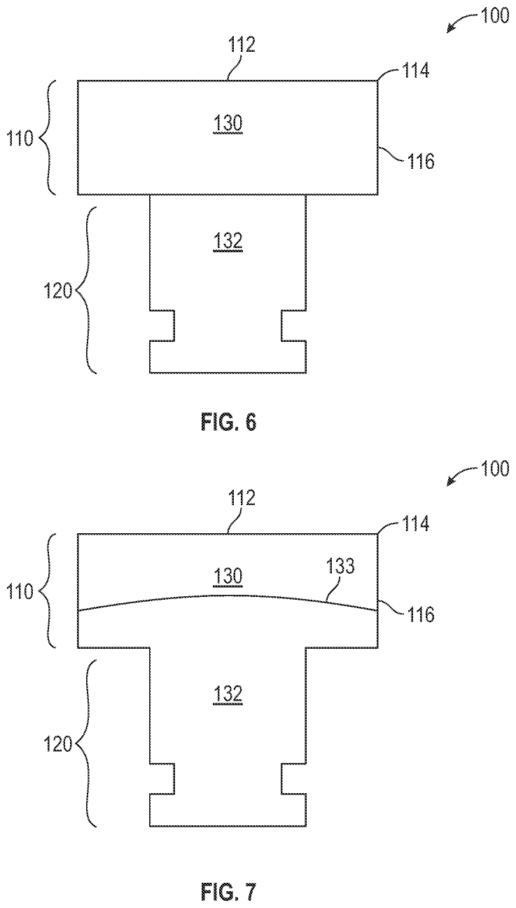

FIGS. 4-7 show example profiles of revolving cutters 100 formed of CFPCD bodies 130 according to embodiments of the present disclosure. As shown in FIG. 4, an entire revolving cutter 100, including the upper body 110 and shaft 120, is formed of a single CFPCD body 130. However, in some embodiments, a CFPCD body may optionally be attached to a substrate to form a revolving cutter. For example, as shown in FIGS. 5 and 7, a CFPCD body 130 is mounted to a substrate 132, where the CFPCD body 130 forms the entire cutting face 112, the entire cutting edge 114, and a portion of the side surface 116. In FIG. 5, the CFPCD body 130 has a thickness 131 extending at least 1 mm from the cutting face 112 and less than the entire thickness of the upper body 110. The substrate 132 forms the entire shaft 120 and a portion of the upper body 110. As discussed in more detail below, the CFPCD body 130 may be brazed to the substrate 132. In such embodiments, a thin layer of brazing material (including reaction products between the brazing material and diamond) may be disposed between the CFPCD body and substrate. As shown in FIG. 6, a revolving cutter 100 is formed of a CFPCD body 130 mounted to a substrate, where the CFPCD body 130 forms the entire upper body 110, including the entire cutting face 112 and the entire side surface 116, and the substrate 132 forms the entire shaft 120. In embodiments having a CFPCD body 130 mounted to a substrate 132, the CFPCD body 130 may be mounted to the substrate 132 at a planar interface 133, e.g., as shown in FIG. 5, or at a non-planar interface 133, e.g., as shown in FIG. 7.

Suitable substrate material may include, but is not limited to, cemented carbides, such as tungsten carbide, titanium carbide, niobium carbide, tantalum carbide, vanadium carbide, and combinations thereof cemented with iron, nickel, cobalt, or alloys thereof, or other transition metal carbides, silicon carbide, and other substrate materials known in the art.

As described above, CFPCD may be formed without the use of a catalyst or binder. Thus, according to embodiments of the present disclosure, the entire CFPCD portion of a revolving cutter may be void of any catalyst or binder material. Additionally, due to the high density of CFPCD (e.g., having less than 1% by volume porosity), infiltration of infiltrant material during attachment of a CFPCD body to a substrate may be avoided, which may result in the CFPCD portion of a revolving cutter being void of infiltrant material after attachment to a substrate. For example, as shown in FIGS. 5-7, a CFPCD body 130 forming at least a portion of the upper body 110 of the revolving cutter 100 is attached to a substrate 132 forming the shaft 120 of the revolving cutter 100. Each of the CFPCD bodies 130 in FIGS. 5-7 may have a microstructure that is void of catalyst, binder, and infiltrant material.

Because CFPCD may be almost 100% diamond with no or little porosity, a CFPCD body may be bonded or joined to a substrate using entirely different methods from conventional processes of bonding a leached PDC body to a substrate. For example, according to embodiments of the present disclosure, a CFPCD may be bonded to a substrate using a brazing material bonded between the CFPCD body and the substrate, where the brazing material may be formed of one or more transition metals. The number of vacancies in the 3 d electron orbits of transition metal determines the interaction behavior with diamond. With respect to their behavior towards carbon, transition metals can be roughly divided into three groups: non-interacting metals, graphitization catalyzer, and carbide former. Titanium (Ti), chromium (Cr), vanadium (V), zirconium (Zr) are examples of transition metals that can actively react with carbon of diamond to form carbides, which can realize the firm holding of diamond particles. Such transition metals would need to be alloyed with other elements to decrease their melting temperature in order to be used for brazing conventionally formed PCD without detrimental graphitization of the diamond. However, because CFPCD bodies disclosed herein have significantly improved thermal stability when compared with conventionally formed PCD, CFPCD bodies may be brazed with transition metals and transition metal alloys having high melting temperatures, e.g., greater than 600° C., greater than 700° C., or greater than 800° C., which may be referred to herein as high temperature brazing material. Examples of high temperature brazing material that may be used to braze a CFPCD body to a substrate include Titanium (Ti), Chromium (Cr), Vanadium (V), Zirconium (Zr), and alloys thereof, e.g., Ag—Cu—Ti, Cu—Sn—Ti and Ni—Cr.

In some embodiments, when high temperature brazing materials are used to braze a CFPCD body to a substrate, the brazing material may react with carbon of the CFPCD body to form a reaction material layer between the CFPCD body and the substrate, which can result in the firm holding of the CFPCD body to the brazing material and attached substrate. In such embodiments, the thin layer of brazing reaction material may be a layer of carbide disposed between the CFPCD body and the substrate, which may be of the same or different type of carbide as the substrate.

Brazing a CFPCD body to a substrate may include interfacing a heated brazing material with the CFPCD body, where the brazing material is heated past its melting temperature to a brazing temperature, e.g., ranging from about 800° F. to about 2,000° F. In some embodiments, a CFPCD body may be bonded to a substrate using a brazing material by reactive wetting, for example, by spreading molten brazing material on the CFPCD body interface surface to bond the brazing material to the CFPCD body and then attaching the brazing material interface surface to the substrate. In some embodiments, a CFPCD body may be bonded to a substrate using a brazing material by laser welding.

In contrast to the brazing process for CFPCD, conventionally formed PCD is typically bonded to a substrate using a sintering process, during which a catalyst or binder will infiltrate into the diamond body to sinter the diamond body to a substrate. Conventionally formed PCD is typically not brazed as the high temperature used to braze the brazing material can graphitize the diamond. However, unlike with conventionally formed diamond bodies, a CFPCD body may be effectively brazed to a substrate using a brazing material (where the brazing material forms the interface between the CFPCD body and substrate) due to the improved thermal stability of CFPCD (formed without any catalyst material) over conventionally formed PCD (or leached PCD).

Additionally, by forming CFPCD (without any catalyst material), the CFPCD body may have higher hardness and strength when compared with conventionally formed PCD. Accordingly, by using a CFPCD body to form a cutting portion of a revolving cutter, CFPCD revolving cutters may have improved cutting performance and longevity when compared with cutting elements using PCD formed with a catalyst material. Additionally, by forming a cutting portion of a revolving cutter with CFPCD, more aggressive cutting geometries may be used when compared with conventionally formed PCD cutting elements. For example, in some embodiments, the side surface of a revolving cutter may include an undulating profile, e.g., a pattern of alternating ridges and grooves, which may extend along the entire side surface thickness, from the cutting edge to a lower side of the upper body. In such embodiments, the cutting edge may also have an undulating profile corresponding with the side surface profile.

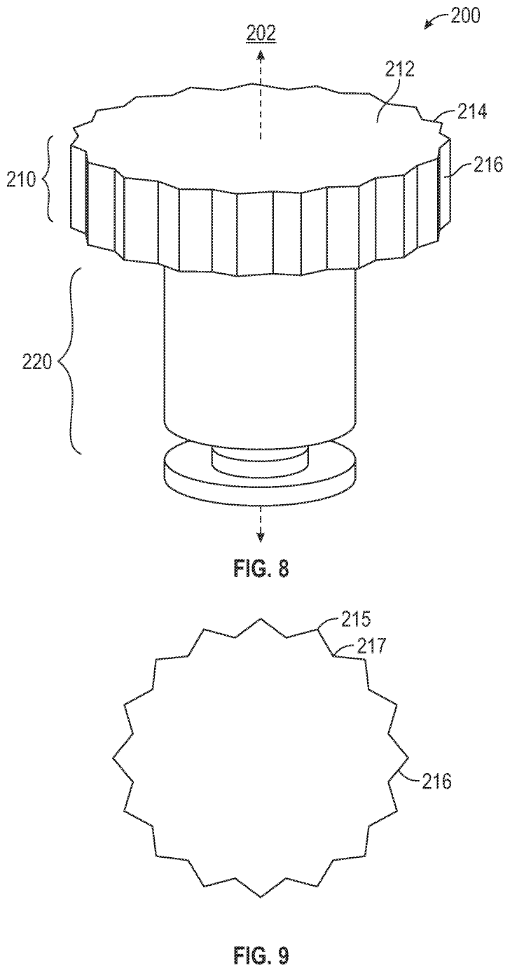

For example, FIGS. 8 and 9 show a perspective view and a top view, respectively, of a revolving cutter 200 according to embodiments of the present disclosure. The revolving cutter 200 includes an upper body 210 and a shaft 220, where the entire revolving cutter is formed of a CFPCD body. The upper body 210 includes a cutting face 212 bordered by a cutting edge 214 and a side surface 216 extending between the cutting edge 214 and a lower side of the upper body 210. As shown, the cutting edge 214 has an undulating profile of alternating ridges 215 and valleys 217. The profile of the cutting edge 214 continues along the entire side surface 216, such that the side surface has a corresponding undulating profile of alternating ridges 215 and valleys 217 when viewed along a lateral cross-section perpendicular to the central longitudinal axis 202 of the cutter. The ridges 215 and valleys 217 have angled apexes. Because the side surface 216 is formed of the CFPCD body (having improved strength compared with conventionally formed PCD), such angled apexes may be used in revolving cutters for downhole drilling applications without experiencing the breakage that may otherwise occur if using conventionally formed PCD. In other embodiments, an undulating profile of the cutting edge and side surface may include rounded apexes. Additionally, according to embodiments of the present disclosure, an undulating profile may be symmetric or asymmetric about the central longitudinal axis 202 of the revolving cutter 200.

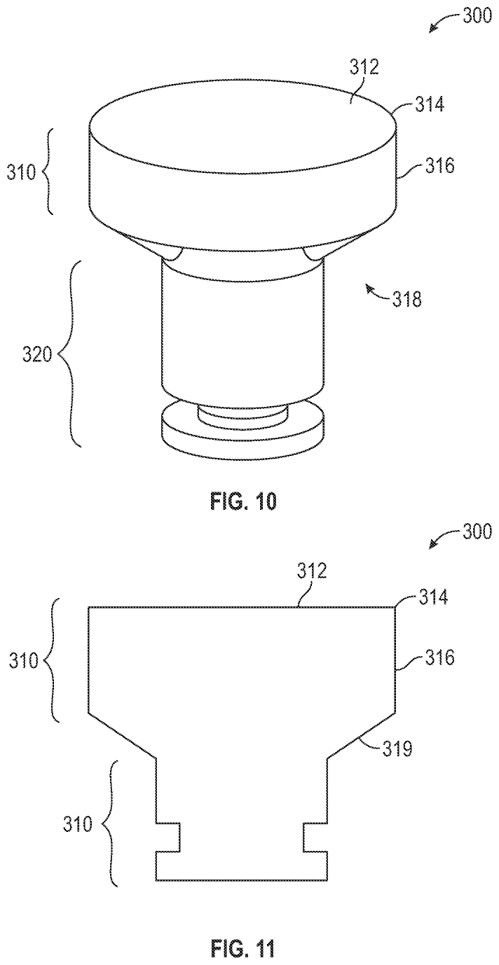

Referring now to FIGS. 10 and 11, another example of a revolving cutter 300 formed entirely of a CFPCD body according to embodiments of the present disclosure is shown. The revolving cutter 300 includes an upper body 310 having a cutting face 312, a cutting edge 314 bordering the cutting face 312, a lower side 318 opposite the cutting face 312, and a side surface 316 extending from the cutting edge 314 to the lower side 318 and defining a diameter of the upper body 310. A shaft 320 extends axially from the lower side 318 of the upper body 310 in a direction away from the cutting surface 312.

In the embodiment shown, the cutting edge 314 is an angled intersection between the cutting face 312 and side surface 316. However, in other embodiments, the cutting edge may be beveled or curved, where the bevel surface or the curved surface extending between the cutting face and the side surface forms the cutting edge.

Additionally, in the embodiment shown, the lower side 318 of the upper body 310 includes a sloped lower surface 319 extending between the side surface 316 and the shaft 320. The lower surface may have a constant slope between the side surface and the shaft, or a varied slope (e.g., curved). According to embodiments of the present disclosure, the lower side of a revolving cutter upper body may interface with a loading surface of a cutting tool pocket (in which the revolving cutter is to be installed) or of a sleeve used to install the revolving cutter to a cutting tool. As such, in one or more embodiments, a sloped lower surface may be used to improve loading conditions between the revolving cutter and the component in which it is installed as the revolving cutter rotates and contacts a working surface.

According to embodiments of the present disclosure, a revolving cutting element may be installed directly in a pocket formed in a tool, where the shaft of the revolving cutting element may interface with and rotate within the pocket. In some embodiments, such as shown in FIG. 3, a sleeve may be used to install a revolving cutting element in a pocket of a tool, where the shaft of the revolving cutting element may interface with and rotate within the sleeve.

For example, FIGS. 12 and 13 show different examples of a revolving cutter 400 mounted in a pocket 402 formed on the blade 404 of a cutting tool according to embodiments of the present disclosure. The pocket 402 is formed at a leading edge of the blade 404, between an outer face 403 of the blade and a leading face 405 of the blade 404. The pocket 402 size and orientation may be designed to provide support to the upper body portion of the revolving cutter 400 and to have the cutting edge 414 of the revolving cutter 400 exposed when the revolving cutter 400 is installed on the blade 404.

In FIG. 12, a sleeve 406 is provided around the shaft portion of the revolving cutter 400, where a circumferential groove 407 in the shaft portion of the revolving cutter 400 is axially aligned with an inner groove 408 in the sleeve 406. A locking mechanism 409 comprising a plurality of bearing balls is disposed between the revolving cutter circumferential groove 407 and the sleeve inner groove 408 to rotatably retain the revolving cutter 400 to the sleeve 406. The sleeve 406, in turn, is attached within the pocket 402 (e.g., by brazing) to connect the revolving cutter 400 to the blade 404.

In FIG. 13, the shaft portion of the revolving cutter 400 is inserted directly into the pocket 402 formed in the blade 404, such that the shaft portion of the revolving cutter 400 interfaces with the pocket 402. A locking mechanism 409 comprising a spring is provided in an inner groove in the pocket 402 and extends into a circumferential groove 407 formed in the shaft portion of the revolving cutter 400 to rotatably retain the revolving cutter 400 to the blade 404. As shown, the pocket inner groove and the cutter circumferential groove 407 are held in a shared axial position by the locking mechanism 409.

In the embodiments shown in FIGS. 12 and 13, different configurations of axially aligned and corresponding grooves with different types of locking mechanisms are shown. For example, corresponding grooves may have a curved profile, as shown in FIG. 12, or an angled profile, as shown in FIG. 13. Additionally, an inner groove may be formed around an entire inner surface of a pocket or sleeve, as shown in FIG. 12, or in one or more discrete circumferential positions around the inner surface of a sleeve or pocket, as shown in FIG. 13. Other configurations of a locking mechanism extending from a pocket or sleeve into a shaft portion of a revolving cutter may be envisioned to rotatably retain the revolving cutter to a cutting tool.

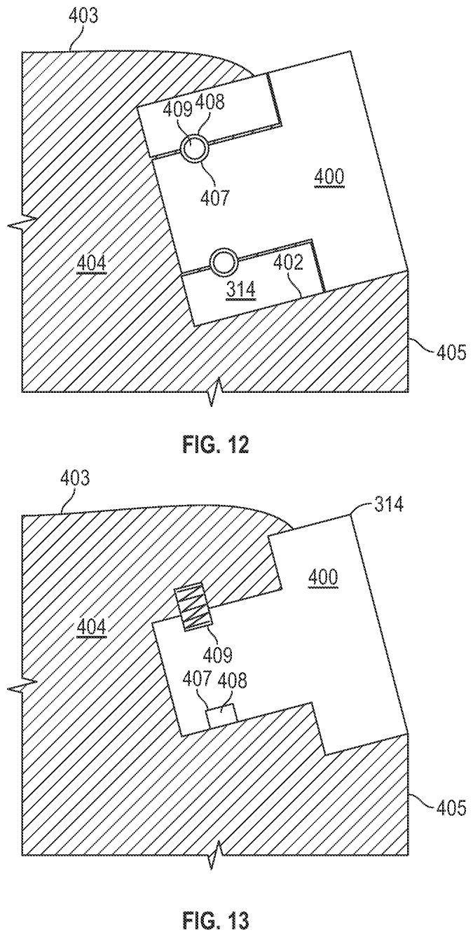

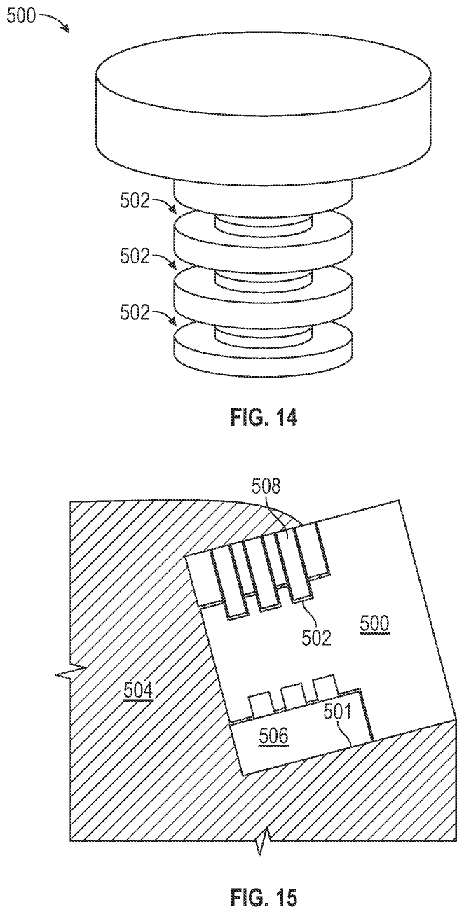

Further, while FIGS. 12 and 13 show a single circumferential groove 407 formed in the shaft portion of the revolving cutter 400 to rotatably retain the revolving cutter 400 to a cutting tool, other embodiments may include more than one circumferential groove formed around a shaft portion of the revolving cutter (e.g., two or three or more circumferential grooves, depending on the size of the revolving cutter). For example, FIGS. 14 and 15 show an example of a revolving cutter 500 having more than one circumferential groove 502 according to embodiments of the present disclosure and its installation in a cutting tool 504. In the embodiment shown, three circumferential grooves 502 are formed at different axial positions along the shaft portion of the revolving cutter 500. The revolving cutter 500 is rotatably retained to a sleeve 506 using at least one locking mechanism 508. For example, a locking mechanism may be a pin that may be extended through an inner groove formed through the sleeve at a discrete location to extend into the circumferential groove. One or more pins may each be inserted through the sleeve to extend into one or more of the multiple circumferential grooves of the revolving cutter. The assembled revolving cutter 500 and sleeve 506 may be attached to a pocket 501 in the cutting tool 504 by brazing, for example.

Revolving cutting elements according to embodiments of the present disclosure may be mounted to a cutting tool, such as a downhole tool having a body with a central axis extending longitudinally therethrough, at least one blade extending outwardly from the body, and a pocket formed in an outer surface of the blade. For example, a downhole tool may be drill bit. According to embodiments of the present disclosure, a single revolving cutting element may be rotatably mounted in a pocket on a cutting tool, or multiple revolving cutting elements may be rotatably mounted to multiple pockets on a cutting tool.

### Methods

According to embodiments of the present disclosure, a CFPCD revolving cutting element may be made by forming a CFPCD body having a selected size and shape, such that the CFPCD body forms a cutting face, a cutting edge, and at least a portion of a side surface of the revolving cutting element. A CFPCD body may be formed by subjecting a volume of diamond powder to ultrahigh pressure and high temperature (UHPHT) sintering without the presence of a catalyst or binder material, for example, under an ultrahigh pressure ranging from 14 to 35 gPa and an ultrahigh temperature ranging from 1,730 to 2,730° C.

As discussed above, during the UHPHT sintering process, the volume of diamond powder may be held in a cavity in a multi-anvil cubic press capable of transferring ultrahigh pressures via multiple fitted-together anvils to the volume of diamond powder. The cavity may have a shape that corresponds to the intended shape of the CFPCD body or to a block form shape. In embodiments where the CFPCD body is sintered in a block form, the CFPCD block form may then be laser cut (or cut with other diamond cutting tools such as a grinder) to form the intended shape of the CFPCD body.

According to embodiments of the present disclosure, a revolving cutter may be formed entirely of a CFPCD body, where the CFPCD is formed to have the intended shape of the revolving cutter. For example, in some embodiments, a CFPCD body may be sintered into a cylindrical block form. The CFPCD block form may then be cut to form a shaft portion, where the shaft portion has a diameter less than the remaining upper body portion of the CFPCD body. In such manner, the CFPCD body may be cut from a block form to have a revolving cutter shape, as described herein, where the CFPCD body forms the entire revolving cutter. In some embodiments, a CFPCD body of a CFPCD revolving cutting element may be formed to also include a shaft having at least one circumferential groove extending around a circumference of the shaft. For example, one or more circumferential grooves may be laser cut around a selected axial location along the shaft.

In some embodiments, a CFPCD body may be formed to have a shape of an upper portion of a CFPCD revolving cutting element, which may then be attached to a substrate, e.g., by brazing, where the substrate forms a shaft having at least one circumferential groove extending around a circumference of the shaft. For example, a CFPCD body may be formed via UHPHT sintering in the desired shape of part or all of an upper portion for a revolving cutter, e.g., in a cylindrical shape. The CFPCD body may then be brazed to a substrate forming the shaft portion of the revolving cutter. In some embodiments, a CFPCD block form may be formed via UHPHT sintering, and the CFPCD block form may then be cut to form a CFPCD body having the intended shape of part of or all of an upper portion for a revolving cutter. For example, a cylindrical CFPCD block form may be laser cut to have a plurality of ridges formed around its circumference to form a CFPCD body with the intended shape of an upper portion of a revolving cutter. The CFPCD body may then be brazed to a substrate to form the revolving cutter.

A CFPCD revolving cutting element may be installed in a pocket formed in an outer surface of a cutting tool. The CFPCD revolving cutting element may be rotatably mounted in the pocket by inserting the shaft of the CFPCD revolving cutting element into the pocket and providing a locking mechanism between the shaft and the pocket, wherein the locking mechanism extends into the circumferential groove of the shaft. In some embodiments, the locking mechanism may extend directly from the pocket into the circumferential groove (e.g., as shown in FIG. 13). In other embodiments, the locking mechanism may extend into the circumferential groove from a sleeve positioned between the pocket and the shaft (e.g., as shown in FIG. 12).

According to embodiments of the present disclosure, one or more CFPCD revolving cutting elements may be rotatably mounted on a cutting tool. When CFPCD revolving cutting elements are rotatably mounted to a cutting tool, the revolving cutting elements may rotate about their respective axes during operation of the cutting tool. For example, in a drilling operation, one or more CFPCD revolving cutting elements may be positioned along the leading edges of the bit body blades so that as the bit body is rotated, the CFPCD revolving cutting element engage and drill the earth formation. The cutting edge of the CFPCD revolving cutting element rotatably mounted to the drill bit may contact the formation during the drilling operation, where the forces between the cutting edge and the earthen formation may rotate the CFPCD revolving cutting element. Such rotation may allow for a cutting portion of the CFPCD revolving cutting element to cut the formation using the entire cutting edge, rather than the same section of the cutting edge, as observed in a fixed cutting element.

Additionally, by forming CFPCD revolving cutting elements according to embodiments of the present disclosure with a CFPCD body that forms the cutting portion of the cutting element, the cutting element may have improved strength and durability through a drilling operation. For example, as known in the art, cobalt and other catalyst materials used to form conventional PCD have a significantly different coefficient of thermal expansion as compared to diamond. Even after treating conventional PCD to remove inert catalyst material, catalyst or binder material may remain trapped in isolated interstitial regions in the PCD. Therefore, upon heating of a conventionally formed PCD cutting portion of a cutting element, e.g., during drilling, the remaining catalyst or binder material and the diamond matrix will expand at different rates, causing cracks to form in the lattice structure and resulting in deterioration of the diamond table. However, by using CFPCD to form the cutting portion of a revolving cutting element, as described herein, the isolated interstitial regions within the CFPCD diamond matrix are void of any catalyst or binder material, thereby reducing differences in thermal expansion in the cutting portion of the cutting element.

Further, by forming the cutting portion of a revolving cutting element with a CFPCD body, which has a higher hardness than conventionally formed PCD, a more aggressive cutting geometry may be used to form the cutting portion of the cutting element, which may improve drilling performance. For example, a CFPCD cutting portion of a revolving cutting element may include a plurality of curved or angled ridges formed around the cutting edge of the cutting element, which may aid in gouging a rock formation during drilling.

The improved properties of CFPCD diamond described above also allow for a revolving cutting element to be entirely formed of CFPCD. When an entire revolving cutting element (e.g., including a cutting portion and a shaft) is formed of CFPCD, connection weakness that would otherwise be present in cutting elements with a diamond body mounted to a substrate are eliminated.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A cutting element, comprising:
an upper body, comprising:
a cutting face bordered by a cutting edge;
a side surface extending from the cutting edge, wherein an upper body diameter is measured between the side surface; and
a catalyst-free polycrystalline diamond (CFPCD) portion forming the cutting face, the cutting edge, and at least a portion of the side surface,
wherein the CFPCD portion comprises:
a diamond matrix formed of a plurality of bonded together diamond grains,
wherein diamond forms at least 99 percent by volume of the CFPCD portion, and
wherein the CFPCD portion extends at least 1 mm from the cutting face; and
a shaft extending from a lower side of the upper body opposite the cutting face, the shaft comprising:
a circumferential groove extending around a circumference of the shaft; and
a shaft diameter less than the upper body diameter.

2. The cutting element of claim 1, wherein the entire CFPCD portion is free of catalyst or binder material.

3. The cutting element of claim 1, wherein the cutting edge has an undulating profile, and wherein the side surface has a corresponding undulating profile comprising alternating ridges and valleys.

4. The cutting element of claim 1, wherein the lower side comprises a sloping surface extending between the side surface and the shaft.

5. The cutting element of claim 1, further comprising at least one additional circumferential groove positioned at a different axial position along the shaft.

6. The cutting element of claim 1, wherein the CFPCD portion forms the entire side surface.

7. The cutting element of claim 1, wherein the CFPCD portion forms the entire upper body and the shaft.

8. The cutting element of claim 1, wherein the CFPCD portion has a thickness extending from the cutting face that is greater than 1 mm.

9. The cutting element of claim 1, further comprising a substrate attached to the CFPCD portion, wherein the substrate forms the shaft.

10. A downhole tool, comprising:
a body having a central axis extending longitudinally therethrough;
a blade extending outwardly from the body;
a pocket formed in an outer surface of the blade; and
a revolving cutting element rotatably mounted in the pocket, the revolving cutting element comprising:
an upper body, comprising:
a cutting face bordered by a cutting edge;
a side surface extending from the cutting edge, wherein an upper body diameter is measured between the side surface; and
a catalyst-free polycrystalline diamond (CFPCD) portion forming the cutting face, the cutting edge, and at least a portion of the side surface,
wherein the CFPCD portion extends at least 1 mm from the cutting face; and
a shaft extending from a lower side of the upper body opposite the cutting face, the shaft comprising:
a circumferential groove extending around a circumference of the shaft; and
a shaft diameter less than the upper body diameter;
a locking mechanism positioned between the pocket and the shaft, wherein the locking mechanism extends into the circumferential groove.

11. The downhole tool of claim 10, wherein the downhole tool is a drill bit.

12. The downhole tool of claim 10, further comprising multiple additional revolving cutting elements positioned in pockets formed in the blade.

13. The downhole tool of claim 10, further comprising a sleeve positioned between the pocket and the shaft, wherein the locking mechanism is positioned between the sleeve and the shaft.

14. The downhole tool of claim 10, wherein the CFPCD portion comprises at least 99.9 percent by volume diamond.

15. A method, comprising:
forming a revolving cutting element, comprising:
forming a catalyst-free polycrystalline diamond (CFPCD) body, comprising:
subjecting a volume of diamond powder to ultrahigh pressure and high temperature (UHPHT) sintering without the presence of a catalyst or binder material, the UHPHT sintering comprising:
an ultrahigh pressure ranging from 14 to 35 gPa; and
an ultrahigh temperature ranging from 1,730 to 2,730° C.,
wherein the CFPCD body forms a cutting face, a cutting edge, and at least a portion of a side surface of the revolving cutting element, and
wherein the revolving cutting element comprises a shaft having a circumferential groove extending around a circumference of the shaft; and
installing the revolving cutting element in a pocket formed in an outer surface of a cutting tool, comprising:
inserting the shaft of the revolving cutting element into the pocket; and
providing a locking mechanism between the shaft and the pocket, wherein the locking mechanism extends into the circumferential groove of the shaft.

16. The method of claim 15, wherein forming the CFPCD body further comprises:
subjecting the volume of diamond powder to UHPHT sintering to form a CFPCD block form; and
cutting the CFPCD block form to a selected shape of the CFPCD body to form the CFPCD body.

17. The method of claim 15, further comprising attaching the CFPCD body to a substrate, wherein the substrate forms the shaft.

18. The method of claim 17, wherein the CFPCD body is brazed to the substrate using a brazing temperature between 800° F. and 2,000° F.

19. The method of claim 15, further comprising inserting the shaft into a sleeve prior to inserting the shaft into the pocket, wherein after the shaft is inserted into the sleeve, the sleeve and shaft is inserted into the pocket, and the locking mechanism extends from the sleeve into the circumferential groove of the shaft.

20. The method of claim 15, further comprising cutting a plurality of ridges around the side surface to form the CFPCD body.
